(19) United States
(12) Patent Application Publication
(10) Pub. No.: US 2019/0198934 A1
(43) Pub. Date: Jun. 27, 2019

(54) METHOD OF GENERATING SILICON THICK ELECTRODES WITH IMPROVED LIFE PERFORMANCE

(71) Applicant: GM GLOBAL TECHNOLOGY OPERATIONS LLC, Detroit, MI (US)

(72) Inventors: Zhongyi Liu, Troy, MI (US); Xiaosong Huang, Novi, MI (US); Yan Wu, Troy, MI (US)

(73) Assignee: GM GLOBAL TECHNOLOGY OPERATIONS LLC, Detroit, MI (US)

(21) Appl. No.: 15/850,614

(22) Filed: Dec. 21, 2017

(51) Int. Cl. H01M 10/0585; H01M 4/485; H01M 4/505; H01M 4/525; H01M 4/62; H01M 4/04; H01M 10/0569

(52) U.S. Cl. CPC H01M 10/0585; H01M 4/485; H01M 4/505; H01M 4/525; H01M 4/625; H01M 2004/027; H01M 4/0419; H01M 4/0409; H01M 4/623; H01M 10/0569; H01M 4/0402

(57) ABSTRACT

An electrode for a battery is provided. The electrode has a first active layer including a first active material, an interlayer including a conductive material, and a second active layer including a second active material. The interlayer is disposed between the first active layer and the second active layer. Methods for fabricating the electrode are also provided.

### INTRODUCTION

This section provides background information related to the present disclosure which is not necessarily prior art.

High-energy density electrochemical cells, such as lithium ion batteries and lithium sulfur batteries can be used in a variety of consumer products and vehicles, such as Hybrid Electric Vehicles (HEVs) and Electric Vehicles (EVs). Typical lithium ion and lithium sulfur batteries comprise a first electrode (e.g., a cathode), a second electrode (e.g., an anode), an electrolyte material, and a separator. Often a stack of battery cells are electrically connected to increase overall output. Conventional lithium ion and lithium sulfur batteries operate by reversibly passing lithium ions between the negative electrode and the positive electrode. A separator and an electrolyte are disposed between the negative and positive electrodes. The electrolyte is suitable for conducting lithium ions and may be in solid or liquid form. Lithium ions move from a cathode (positive electrode) to an anode (negative electrode) during charging of the battery, and in the opposite direction when discharging the battery.

In order to increase a battery's energy output, electrodes may be thickened. However, for any given colloidal dispersion of electrode active material, there is a breakpoint with increasing thickness from crack free to cracked, which can potentially diminish electrode mechanical integrity and battery life. This breaking point is referred to as a critical cracking thickness (CCT). Therefore, electrodes with increased strength and cycling lifetime that overcome the CCT are desired.

### SUMMARY

This section provides a general summary of the disclosure, and is not a comprehensive disclosure of its full scope or all of its features.

In various aspects, the present technology provides an electrode including a first active layer having a first active material; an interlayer having a conductive material; and a second active layer having a second active material. The interlayer is disposed between the first active layer and the second active layer.

In one aspect, one of the first active layer and the second active layer is disposed on a current collector comprising a material selected from the group consisting of copper, aluminum, carbon, lithium, nickel, stainless steel, tantalum, titanium, tungsten, vanadium, and combinations thereof.

In one aspect, the electrode is an anode and the first active material and the second active material independently include a negative electroactive material.

In one aspect, the first active material and the second active material are independently selected from the group including graphite, lithium titanate oxide Li₄Ti₅O₁₂ (LTO), metal oxides of MO where M is selected from the group consisting of cobalt (Co), nickel (Ni), copper (Cu), or iron (Fe), silicon (Si), silicon nanoparticles, silicon-containing alloys, tin (Sn), tin-containing alloys, and combinations thereof.

In one aspect, the electrode is a cathode and the first active material and the second active material independently include a positive electroactive material.

In one aspect, the first active material and the second active material are independently selected from the group including transition metal oxides, olivine-structured LiMPO₄ where M is Fe, Mn, Co, or Ni, layer oxides of LiMO₂ wherein M is Mn, Ni, Co, or Cr, spinel-structured LiM₂O₄ where M is Mn or Fe, and combinations thereof.

In one aspect, the conductive material includes carbon.

In one aspect, the conductive material is selected from the group including carbon, diamond-like carbon, carbon fibers, carbon nanotubes, carbon black, metallic wires, metallic particulates, and combinations thereof.

In various aspects, the present technology also provides an electrode including a first active layer disposed on a copper substrate, the first active layer including silicon (Si); an interlayer disposed on the first active layer such that the first active layer is located between the copper substrate and the interlayer, the interlayer including carbon; and a second active layer disposed on the interlayer such that the interlayer is located between the first active layer and the second active layer, the second active layer including Si.

In one aspect, the first active layer, the interlayer, and the second active layer have a combined thickness of greater than or equal to about 15 μm to less than or equal to about 450 μm.

In one aspect, the electrode is located in a battery.

In various aspects, the present technology yet further provides a method of fabricating an electrode. The method includes disposing a first composition including a first active material onto a substrate; annealing the first composition to generate a first active layer on the substrate; disposing a second composition including a conductive material onto the first active layer; annealing the second composition to generate an interlayer on the first active layer; disposing a third composition including a second active material onto the interlayer; and annealing the third composition to generate a second active layer on the interlayer.

In one aspect, the first composition is a first aqueous ink, the second composition is a non-aqueous ink, and the third composition is a second aqueous ink, and the method further includes generating the first aqueous ink and the second aqueous ink individually and independently by combining one of the first active material and the second active material, a first conductive filler, a first binder, and an aqueous solvent; and generating the second composition by combining: the conductive material, a second conductive filler, a second binder, and a non-aqueous solvent.

In one aspect, the disposing the first composition, the second composition, and the third composition is performed individually and independently by spreading with a doctor blade, die coating, or spray coating.

In one aspect, the annealing the first composition, the second composition, and the third composition includes individually and independently incubating the first composition, the second composition, and the third composition at a temperature of greater than or equal to about ambient temperature to less than or equal to about 120° C. for a time of greater than or equal to about 30 seconds to less than or equal to about 12 hours.

In one aspect, the first active material and the second active material are independently selected from the group including graphite, lithium titanate oxide Li₄Ti₅O₁₂ (LTO), metal oxides of MO where M is selected from the group consisting of cobalt (Co), nickel (Ni), copper (Cu), or iron (Fe), silicon (Si), silicon nanoparticles, silicon-containing alloys, tin (Sn), tin-containing alloys, and combinations thereof, and the conductive material is selected from the group including carbon, diamond-like carbon, carbon fibers, carbon nanotubes, carbon black, metallic wires, metallic particulates, and combinations thereof.

In one aspect, the first composition is disposed onto a first decal, the second composition is disposed onto a second decal, and the third composition is disposed onto a third decal, and disposing the first composition, the second composition, and the third composition is performed individually and independently by disposing the first decal, the second decal, or the third decal onto the substrate, the first active layer, or the interlayer, respectively.

In one aspect, the annealing the first composition, the second composition, and the third composition includes individually and independently hard pressing the first decal, the second decal, and the third decal.

In one aspect, after the annealing the method includes removing the first decal from the first composition, removing the second decal from the second composition, and removing the third decal form the third composition.

In one aspect, the method further includes generating an additional interlayer on the second active layer, and generating an additional active layer on the additional interlayer.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic of an exemplary electrochemical battery cell.

FIG. 2 is a schematic of an electrode according to various aspects of the current technology.

FIG. 3A is a schematic of an ink including an active material according to various aspects of the current technology.

FIG. 3B is a schematic of an ink including a conductive material according to various aspects of the current technology.

FIG. 4A is a schematic of a decal with a composition including an active material in accordance with various aspects of the current technology.

FIG. 4B is a schematic of a decal with a composition including a conductive material in accordance with various aspects of the current technology.

FIG. 5 is a graph showing normalized capacity (y-axis) versus cycle number (x-axis) for electrodes having single active layers with thickness of 90 μm, 160 μm, and 220 μm.

FIG. 6 is a graph showing discharge capacity (left y axis) and coulombic efficiency (right y axis) versus cycle number (x axis) for an electrode having a single active layer and an electrode having a tri-layer design according to various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to improved electrochemical cells, including batteries, especially lithium ion batteries and lithium sulfur batteries that may be used in vehicle applications. More particularly, the present technology addresses critical cracking thickness (CCT) limitations that may otherwise arise, so as to substantially improve: (1) an electrode's coating quality and mechanical integrity, and (2) the battery's energy output and life performance.

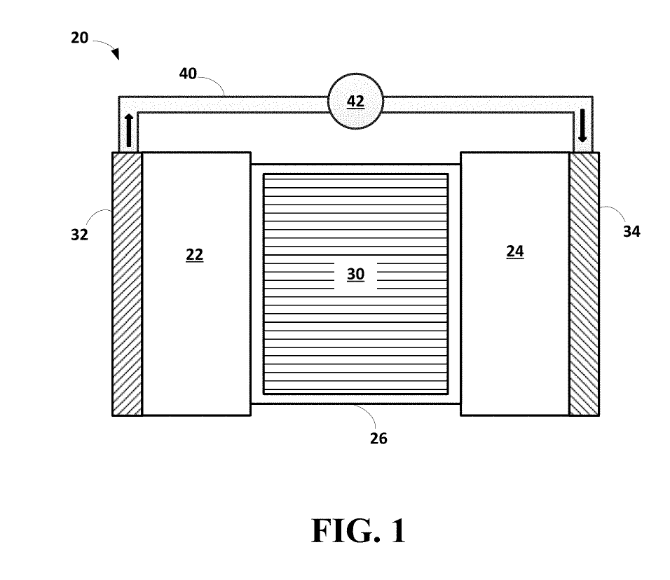

An exemplary and schematic illustration of a battery 20 is shown in FIG. 1. The battery may be a lithium ion electrochemical cell or a lithium sulfur electrochemical cell. The battery 20 includes a negative electrode 22, a positive electrode 24, and a separator 26 (e.g., a microporous polymeric separator) disposed between the two electrodes 22, 24. The separator 26 comprises an electrolyte 30, which may also be present in the negative electrode 22 and the positive electrode 24. A negative electrode current collector 32 may be positioned at or near the negative electrode 22 and a positive electrode current collector 34 may be positioned at or near the positive electrode 24. The negative electrode current collector 32 and the positive electrode current collector 34 respectively collect and move free electrons to and from an external circuit 40. The interruptible external circuit 40 and a load device 42 connect the negative electrode 22 (through its current collector 32) and the positive electrode 24 (through its current collector 34). Each of the negative electrode 22, the positive electrode 24, and the separator 26 may further comprise the electrolyte 30 capable of conducting lithium ions. The separator 26 operates as both an electrical insulator and a mechanical support, by being sandwiched between the negative electrode 22 and the positive electrode 24 to prevent physical contact and thus, the occurrence of a short circuit. The separator 26, in addition to providing a physical barrier between the two electrodes 22, 24, can provide a minimal resistance path for internal passage of lithium ions (and related anions) for facilitating functioning of the battery 20.

The battery 20 can generate an electric current during discharge by way of reversible electrochemical reactions that occur when the external circuit 40 is closed (to connect the negative electrode 22 and the positive electrode 24) when the negative electrode 22 contains a relatively greater quantity of intercalated lithium. The chemical potential difference between the positive electrode 24 and the negative electrode 22 drives electrons produced by the oxidation of intercalated lithium at the negative electrode 22 through the external circuit 40 toward the positive electrode 24. Lithium ions, which are also produced at the negative electrode 22, are concurrently transferred through the electrolyte 30 and the separator 26 towards the positive electrode 24. The electrons flow through the external circuit 40 and the lithium ions migrate across the separator 26 in the electrolyte 30 to form intercalated lithium at the positive electrode 24. The electric current passing through the external circuit 40 can be harnessed and directed through the load device 42 until the intercalated lithium in the negative electrode 22 is depleted and the capacity of the battery 20 is diminished.

The battery 20 can be charged or re-powered at any time by connecting an external power source to the battery 20 to reverse the electrochemical reactions that occur during battery discharge. The connection of an external power source to the battery 20 compels the otherwise non-spontaneous oxidation of intercalated lithium at the positive electrode 24 to produce electrons and lithium ions. The electrons, which flow back towards the negative electrode 22 through the external circuit 40, and the lithium ions, which are carried by the electrolyte 30 across the separator 26 back towards the negative electrode 22, reunite at the negative electrode 22 and replenish it with intercalated lithium for consumption during the next battery discharge cycle. The external power source that may be used to charge the battery 20 may vary depending on the size, construction, and particular end-use of the battery 20. Some notable and exemplary external power sources include, but are not limited to, an AC wall outlet and a motor vehicle alternator. In many lithium ion battery and lithium sulfur battery configurations, each of the negative electrode current collector 32, the negative electrode 22, the separator 26, the positive electrode 24, and the positive electrode current collector 34 are prepared as relatively thin layers (for example, several micrometers or a millimeter or less in thickness) and assembled in layers connected in electrical parallel arrangement to provide a suitable energy package.

Furthermore, the battery 20 can include a variety of other components that while not depicted here are nonetheless known to those of skill in the art. For instance, the battery 20 may include a casing, gaskets, terminal caps, and any other conventional components or materials that may be situated within the battery 20, including between or around the negative electrode 22, the positive electrode 24, and/or the separator 26, by way of non-limiting example. As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium ion cells or batteries to produce a greater voltage output and power density if it is required by the load device 42.

Accordingly, the battery 20 can generate electric current to the load device 42 that can be operatively connected to the external circuit 40. The load device 42 may be powered fully or partially by the electric current passing through the external circuit 40 when the battery 20 is discharging. While the load device 42 may be any number of known electrically-powered devices, a few specific examples of power-consuming load devices include an electric motor for a hybrid vehicle or an all-electrical vehicle, a laptop computer, a tablet computer, a cellular phone, and cordless power tools or appliances, by way of non-limiting example. The load device 42 may also be a power-generating apparatus that charges the battery 20 for purposes of storing energy.

Any appropriate electrolyte 30, whether in solid form or solution, capable of conducting lithium ions between the negative electrode 22 and the positive electrode 24 may be used in the battery 20. In certain aspects, the electrolyte solution may be a non-aqueous liquid electrolyte solution that includes a lithium salt dissolved in an organic solvent or a mixture of organic solvents. Numerous conventional non-aqueous liquid electrolyte 30 solutions may be employed in the battery 20. A non-limiting list of lithium salts that may be dissolved in an organic solvent to form the non-aqueous liquid electrolyte solution include LiPF₆, LiClO₄, LiAlCl₄, LiI, LiBr, LiSCN, LiBF₄, LiB(C₆H₅)₄, LiAsF₆, LiCF₃SO₃, LiN(CF₃SO₂)₂, and combinations thereof. These and other similar lithium salts may be dissolved in a variety of organic solvents, including but not limited to various alkyl carbonates, such as cyclic carbonates (ethylene carbonate (EC), propylene carbonate (PC), butylene carbonate(BC)), acyclic carbonates (dimethyl carbonate (DMC), diethyl carbonate (DEC), ethylmethylcarbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1-2-diethoxyethane, ethoxymethoxyethane), cyclic ethers (tetrahydrofuran, 2-methyltetrahydrofuran), and mixtures thereof.

The separator 26 may comprise, in one embodiment, a microporous polymeric separator comprising a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of PE and PP.

When the separator 26 is a microporous polymeric separator, it may be a single layer or a multi-layer laminate, which may be fabricated from either a dry or a wet process. For example, in one embodiment, a single layer of the polyolefin may form the entire microporous polymer separator 26. In other aspects, the separator 26 may be a fibrous membrane having an abundance of pores extending between the opposing surfaces and may have a thickness of less than a millimeter, for example. As another example, however, multiple discrete layers of similar or dissimilar polyolefins may be assembled to form the microporous polymer separator 26. The microporous polymer separator 26 may also comprise other polymers in addition to the polyolefin such as, but not limited to, polyethylene terephthalate (PET), polyvinylidene fluoride (PVDF), and/or a polyamide. The polyolefin layer, and any other optional polymer layers, may further be included in the microporous polymer separator 26 as a fibrous layer to help provide the microporous polymer separator 26 with appropriate structural and porosity characteristics. Various conventionally available polymers and commercial products for forming the separator 26 are contemplated, as well as the many manufacturing methods that may be employed to produce such a microporous polymer separator 26.

In a lithium ion battery, the positive electrode (cathode) 24 may be formed from a lithium-based electroactive material that can sufficiently undergo lithium intercalation and deintercalation while functioning as the positive terminal of the battery 20. The positive electrode 24 may include a polymeric binder material to structurally fortify the lithium-based active material. One exemplary common class of known positive electroactive materials that can be used to form the positive electrode 24 is transitional metal oxides, including nickel transition metal oxides and layered lithium transition metal oxides. For example, in certain embodiments, the positive electrode 24 may comprise at least one spinel comprising a transition metal like lithium manganese oxide (Li₍₁₊ₓ₎Mn₍₂₋ₓ₎O₄), where 0≤x≤1, where x is typically less than 0.15, including LiMn₂O₄, lithium manganese nickel oxide (LiMn₍₂₋ₓ₎NiₓO₄), where 0≤x≤1 (e.g., LiMn_{1.5}Ni_{0.5}O₄), lithium cobalt oxide (LiCoO₂), lithium manganese oxide (LiMn₂O₄), lithium nickel oxide (LiNiO₂), a lithium nickel manganese cobalt oxide (Li(NiₓMn_{y}Co_{z})O₂), where 0≤x≤1, 0≤y≤1, 0≤z≤1, and x+y+z=1, including LiMn_{0.33}Ni_{0.33}Co_{0.33}O₂, a lithium nickel cobalt metal oxide (LiNi_{(1-x-y)}CoₓM_{y}O₂), where 0<x<1, y<1, and M may be Al, Mn, or the like, other known lithium-transition metal oxides or mixed oxides lithium iron phosphates, or a lithium iron polyanion oxides such as lithium iron phosphate (LiFePO₄) or lithium iron fluorophosphate (Li₂FePO₄F). Such active materials may be intermingled with at least one polymeric binder, for example, by slurry casting active materials with such binders, like polyvinylidene fluoride (PVDF), ethylene propylene diene monomer (EPDM) rubber, or carboxymethoxyl cellulose (CMC). The positive electrode current collector 34 may be formed from aluminum or any other appropriate electrically conductive material known to those of skill in the art.

In a lithium sulfur battery, the positive electrode can include sulfur-based compounds for a positive active material. A sulfur-based compound may be selected from at least one of: elemental sulfur, Li₂Sn (wherein n is greater than or equal to 1), Li₂Sn (wherein n is greater than or equal to 1) dissolved in a catholyte, an organosulfur compound, and a carbon-sulfur polymer ((C₂Sₓ)ₙ: wherein x=2.5, and n is 2 or greater). The positive electrode may also include electrically conductive materials that facilitate the movement of the electrons within the positive electrode, for example, graphite, carbon-based materials, or a conductive polymer. Carbon-based materials may include, by way of non-limiting example, ketchen black, denka black, acetylene black, carbon black, and the like. Examples of a conductive polymer include polyaniline, polythiophene, polyacetylene, polypyrrole, and the like. The conductive material may be used singularly or as a mixture of two or more materials. The positive electrode may also include a polymeric binder as described above.

The negative electrode (anode) 22 includes a negative electroactive material as a lithium host material capable of functioning as a negative terminal of a lithium ion battery. The negative electrode 22 may also include another electrically conductive material, as well as one or more polymeric binder materials to structurally hold the lithium host material together. For example, in certain embodiments, the negative electrode 22 may comprise graphite, lithium titanate oxide Li₄Ti₅O₁₂ (LTO), silicon, silicon-containing alloys, tin (Sn), tin-containing alloys, antimony (Sb), germanium (Ge), alloys thereof, and combinations thereof.

Graphite is often used to form the negative electrode 22 because it exhibits advantageous lithium intercalation and deintercalation characteristics, is relatively non-reactive in the electrochemical cell environment, and can store lithium in quantities that provide a relatively high energy density. Commercial forms of graphite and other graphene materials that may be used to fabricate the negative electrode 22 are available from, by way of non-limiting example, Timcal Graphite and Carbon of Bodio, Switzerland, Lonza Group of Basel, Switzerland, or Superior Graphite of Chicago, United States of America. Other materials can also be used to form the negative electrode 22, including, for example, lithium-silicon and silicon containing binary and ternary alloys and/or tin-containing alloys, such as Si—Sn, SiSnFe, SiSnAl, SiFeCo, SnO₂, and the like. In certain alternative embodiments, lithium-titanium anode materials are contemplated, such as Li₄₊ₓTi₅O₁₂, where 0≤x≤3, including lithium titanate (Li₄Ti₅O₁₂) (LTO). Any of these negative electroactive materials may of course be combined with other electroactive materials.

In one variation, the negative electrode 22 may be formed from lithium titanate oxide (LTO) particles intermingled in at least one of polyvinylidene fluoride (PVDF), a nitrile butadiene rubber (NBR), styrene-butadiene rubber (SBR) binder, or carboxymethoxyl cellulose (CMC) as will be discussed in greater detail below, by way of non-limiting example. The negative electrode current collector 32 may be formed from copper or any other appropriate electrically conductive material known to those of skill in the art.

In certain aspects of the present disclosure, at least one of the positive electrode 24 and the negative electrode 22 is modified in accordance with certain principles of the present teachings. For example, the present teachings provide a thick battery electrode that utilizes a multi-layer design. Relative to electrodes with a single active layer, this design provides a stronger electrode, improves battery energy output, improves electrical conductivity, prevents cracking, and results in improved cycling stability and lifetime. The electrode is at least one of an anode or a cathode in a battery for powering, for example, a battery electric vehicle (BEV), a plug-in hybrid electric vehicle (PHEV), or a hybrid electric vehicle (HEV).

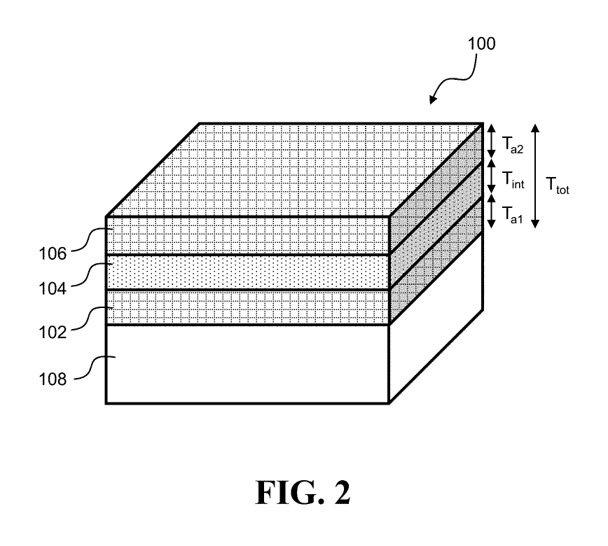

FIG. 2 shows an exemplary electrode 100 according to the present technology. The electrode 100 comprises a first active layer 102 comprising a first active material, an interlayer 104 comprising a conductive material, and a second active layer 106 comprising a second active material. The interlayer 104 is disposed between the first active layer 102 and the second active layer 106. As shown in FIG. 2, the first active layer 102 is disposed on a substrate 108. However, in various embodiments, one of the first active layer and the second active layer is disposed on the substrate 108. As provided above, the electrode 100 can be an anode (i.e., a negative electrode) or a cathode (i.e., a positive electrode).

The first active material of the first active layer 102 can be the same or different material as the second active material of the second active layer 106. In some embodiments, the electrode 100 is an anode and the first active material and the second active material individually and independently comprise a negative electroactive material. The negative electroactive material can be any negative electroactive anode material described above, including, as non-limiting examples, graphite, lithium titanate oxide (Li₄Ti₅O₁₂; LTO), metal oxides (based on a conversion reaction) MO where M is Co, Ni, Cu, or Fe, silicon (Si), Si nanoparticles, silicon-containing alloys, tin, tin-containing alloys, or combinations thereof. In other embodiments, the electrode 100 is a cathode and the first active material and the second active material individually and independently comprise a positive electroactive cathode material. The positive electroactive material can be any electroactive anode material described above, including, as non-limiting examples, transition metal oxides, such as MnO₂, V₂O₃, Olivine-structured LiMPO₄ where M is Fe, Mn, Co or Ni, layered oxides LiMO₂ where M is Mn, Ni, Co, or Cr, and spinel-structured LiM₂O₄ where M is Mn or Fe, sulfur-based compounds, other electrically conductive materials, and combinations thereof.

The first active layer 102 and the second active layer 106 have an independent and individual thickness, Tₐ₁ and Tₐ₂, respectively, of greater than or equal to about 5 μm to less than or equal to about 150 μm, greater than or equal to about 10 μm to less than or equal to about 100 μm, greater than or equal to about 25 μm to less than or equal to about 75 μm, greater than or equal to about 30 μm to less than or equal to about 60 μm, or greater than or equal to about 40 μm to less than or equal to about 50 μm. For example, the first and second active layers 102, 106 can independently and individually have a thickness Tₐ₁, Tₐ₂ of about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, or about 150 μm.

The conductive material of the interlayer 104 comprises carbon. As non-limiting examples, the conductive material is selected from the group consisting of carbon (such as G8 carbon), diamond-like carbon, carbon fibers, carbon nanotubes, carbon black, metallic wires (such as, for example, copper wires), metallic particulates, and combinations thereof. The interlayer 104 provides mechanical integrity and high conductivity to the electrode 100.

The interlayer 104 has a thickness Tᵢₙₜ of greater than or equal to about 5 μm to less than or equal to about 150 μm, greater than or equal to about 25 μm to less than or equal to about 125 μm, greater than or equal to about 30 μm to less than or equal to about 100 μm, greater than or equal to about 40 μm to less than or equal to about 90 μm, or greater than or equal to about 50 μm to less than or equal to about 80 μm. For example, the interlayer 104 can have a thickness Tᵢₙₜ of about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, or about 150 μm.

The first and second active layers 102, 106 and the interlayer 104 have a collective total thickness Tₜₒₜ of greater than or equal to about 15 μm to less than or equal to about 450 μm, greater than or equal to about 50 μm to less than or equal to about 400 μm, greater than or equal to about 100 μm to less than or equal to about 300 μm, greater than or equal to about 150 μm to less than or equal to about 250 μm, or greater than or equal to about 175 μm to less than or equal to about 225 μm. For example, the first and second active layers 102, 106 and the interlayer 104 can have a collective total thickness Tₜₒₜ of about 15 μm, about 25 μm, about 50 μm, about 75 μm, about 100 μm, about 125 μm, about 150 μm, about 175 μm, about 200 μm, about 225 μm, about 250 μm, about 275 μm, about 300 μm, about 325 μm, about 350 μm, about 375 μm, about 400 μm, about 425 μm, or about 450 μm.

The substrate 108 is a current collector and comprises, as non-limiting examples, copper, aluminum, carbon, lithium, nickel, stainless steel, tantalum, titanium, tungsten, vanadium, and combinations thereof. In various embodiments the substrate 108 (current collector) is provided as a foil. The first active layer 102 is disposed directly on the substrate in various embodiments. In some embodiments, although not shown in FIG. 2, the substrate comprises a thin, i.e., less than or equal to about 20 μm, layer of a conducting material. The conducting material can be any material suitable for the interlayer 104. In such embodiments, the first active layer 102 is disposed on the thin layer.

An electrode having a single active layer can be modified by increasing the thickness of the active layer. However the thickness is limited by a critical cracking thickness (CCT) for the active layer material. The electrode 100 provides a high thickness by providing the interlayer 104 between first and second active layers 102, 106. Additional layers may be included with the proviso that an interlayer is located between active layers. This design provides an improved battery energy output, improved conductivity by providing multiple electron routes (from a single active layer contact to active layer-interlayer-active layer plane contact), improved mechanical integrity by overcoming a CCT of a single layer, and improved battery energy density and life performance.

The current technology also provides a battery comprising the electrode 100. In some embodiments, the electrode 100 is present in the battery as at least one of an anode and a cathode. The battery is suitable for a BEV, PHEV, HEV, or other electric vehicles and applications.

The current technology further provides a method of fabricating an electrode, such as the electrode 100 described with reference to FIG. 2. The method comprises disposing a first composition comprising a first active material onto a substrate; annealing the first composition to generate a first active layer on the substrate, disposing a second composition comprising a conductive material onto the first active layer, annealing the second composition to generate an interlayer on the first active layer, disposing a third composition comprising a second active material onto the interlayer, and annealing the third composition to generate a second active layer on the interlayer.

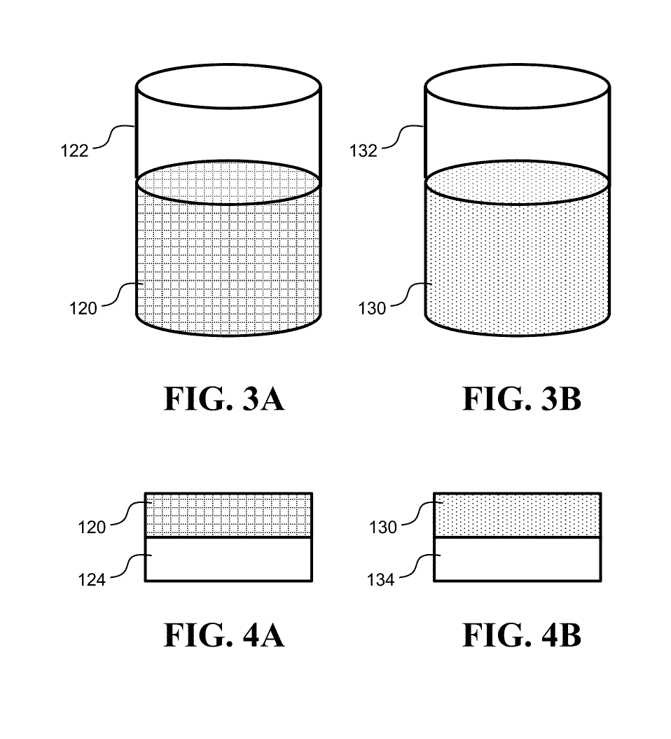

The first composition is a first ink, the second composition is a second ink, and the third composition is a third ink. In some embodiments, the method further comprises generating the first ink and the third ink individually and independently by combining one of the first active material and the second active material, a first conductive filler, a first binder, and an aqueous solvent or a non-aqueous solvent. The first and third ink comprise 20-80 wt. % first or second active material, 10-30 wt. % first filler, 10-30 wt. % first binder, and first solvent to 100 wt. % Where the first active material is the same as the second active material, only a single ink is required to be made. The first and second active materials can be negative electroactive materials or positive electroactive materials, as described above. Moreover, the first and second active materials are the same material or different materials. The method may also comprise generating the second ink by combining the conductive material, a second conductive filler, a second binder, and a second solvent. The second ink comprises 75-94 wt. % conductive material, 3-10 wt. % second filler, 3-10 wt. % second binder, and second solvent to 100 wt. % The conductive material can be any conductive material describe above in regard to the interlayer. The first and second conductive filler can be carbon (such as G8 carbon), diamond-like carbon, carbon fibers, carbon nanotubes, carbon black, metallic wires (such as, for example, copper wires), metallic particulates, and combinations thereof. The first and second binder can independently be sodium alginate, poly(vinylidene fluoride) (PVDF), polytetrafluoroethylene (PTFE), ethylene propylene diene monomer (EPDM) rubber, carboxymethyl cellulose (CMC), lithium polyacrylate (LiPAA), sodium polyacrylate (NaPAA), polyacrylic acid (PAA), lithium alginate, and combinations thereof. The solvent can be an aqueous solvent such as water or a non-aqueous solvent such as N-methyl-2-pyrrolidone (NMP). FIG. 3A shows a first or third ink composition 120 in a first container 122. FIG. 3B shows a second ink composition 130 in a second container 132.

In some aspects of the current technology, the disposing the first composition, the second composition, and the third composition is performed individually and independently by spreading with a doctor blade, die coating, or spray coating. More specifically, the first ink is disposed on a substrate and annealed to form the first layer, the second ink is disposed on the first active layer and annealed to form the interlayer, and the third ink is disposed on the interlayer and annealed to form the second active layer. The annealing the first composition, the second composition, and the third composition comprises individually and independently incubating the first composition, the second composition, and the third composition at a temperature of greater than or equal to about ambient temperature to less than or equal to about 120° C. for a time of greater than or equal to about 30 seconds to less than or equal to about 12 hours. Here, the first and third composition should be immiscible with the second composition. Therefore, where the first and third ink compositions 120 comprise an aqueous solvent, the second ink composition 130 comprises a non-aqueous solvent. Conversely, where the first and third ink compositions 120 comprise a non-aqueous solvent, the second ink composition 130 comprises an aqueous solvent. Additional layers can be disposed on the second active layer with the proviso that interlayers are located between active layers. For example, the method can also include generating an additional interlayer on the second active layer, and generating an additional active layer on the additional interlayer, and so on until a predetermined number of layers has been generated.

In other aspects of the current technology, as shown in FIG. 4A, the first and third compositions 120 are disposed onto individual first and third decals 124 as first and third inks, and, as shown in FIG. 4B, the second composition is disposed onto a second decal 134 as a second ink. Here, the disposing the first composition, the second composition, and the third composition is performed individually and independently by disposing the first decal, the second decal, or the third decal onto the substrate, the first active layer, or the interlayer, respectively. The annealing the first composition, the second composition, and the third composition comprises individually and independently hard pressing the first decal, the second decal, and the third decal. After the annealing, the method comprises removing the first decal from the first composition, removing the second decal from the second composition, and removing the third decal from the third composition.

For example, the first decal 124 is positioned on a substrate such that the first composition is in contact with the substrate. The first composition is annealed to the substrate by pressing and the first decal 124 is removed to expose a first active layer comprising the first composition. The second decal 134 is then positioned on the first active layer such that the second composition is in contact with first active layer. The second composition is annealed to the first active layer by pressing and the second decal 134 is removed to expose an interlayer. The third decal 124 (which may include the same active material as the first decal 124) is then positioned on the interlayer such that the third composition is in contact with the interlayer. The third composition is annealed to the interlayer by pressing and the third decal 124 is removed to expose a second active layer.

Embodiments of the present technology are further illustrated through the following non-limiting examples.

### Example 1

Electrodes having a single active layer of varying thicknesses (90 μm, 160 μm, and 220 μm) are fabricated. The electrodes are then examined in duplicate to determine how active layer thickness affects capacity over a course of cycles.

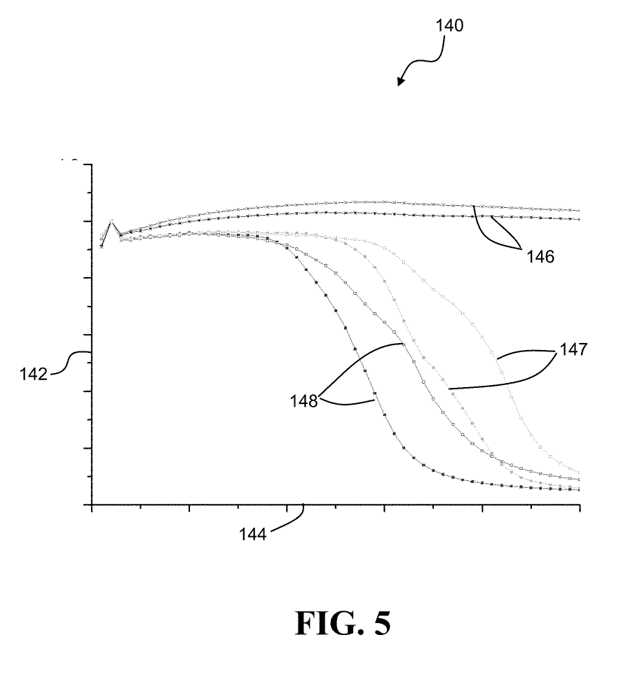

FIG. 5 shows a graph 140 providing test results for the electrodes. The graph 140 has a y-axis 142 representing normalized capacity (from 0-1.2) and an x-axis 144 representing cycle number (from 0 to 50 cycles). Capacity curves for electrodes having an active layer thickness of 90 μm 146, an active layer thickness of 160 μm 147, and an active layer thickness of 220 μm 148 are plotted on the graph 140. The graph 140 shows that capacity decreases with decreasing cycle number as the active layer thickness increases.

### Example 2

An aqueous ink is generated comprising 60 wt. % nanoparticles as an active material, 20 wt. % carbon black as a first conductive filler, 20 wt. % of sodium algnate as a first binder, and water as an aqueous solvent.

A non-aqueous ink is generated comprising 88 wt. % G8 carbon as a conductive material, 6 wt. % carbon black as a second conductive filler, 6 wt. % of PVDF as a second binder, and NMP as an aqueous solvent.

The aqueous ink is spread onto a copper foil substrate and annealed at ambient temperature to generate a first active layer. The non-aqueous ink is then spread onto the first active layer and annealed at ambient temperature to generate an interlayer. The aqueous ink is then spread onto the interlayer and annealed at ambient temperature to generate a second active layer. Collectively, a tri-layered electrode having a tri-layer thickness of about 200 μm is generated.

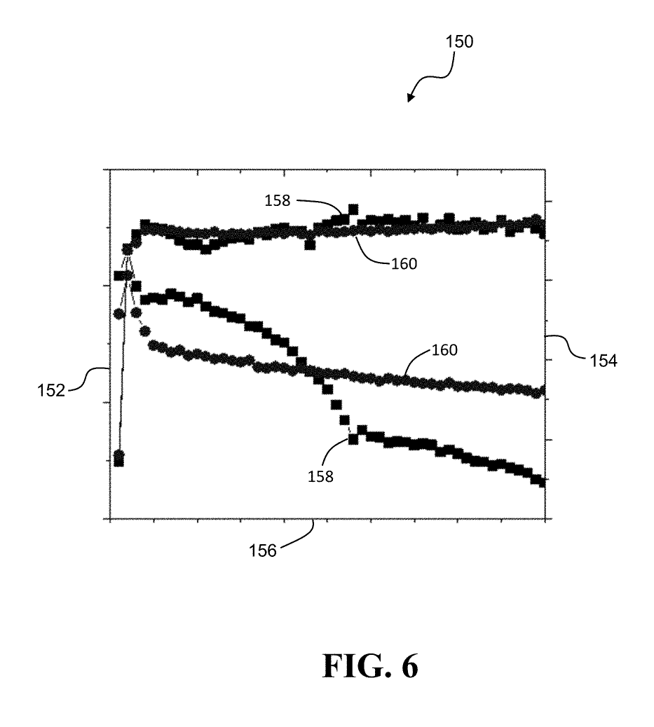

Experiments are performed to compare the tri-layered electrode with a second electrode comprising a single active layer having a thickness of about 150-200 μm. The results are tabulated in a graph 150 provided in FIG. 6. The graph 150 has a left y-axis 152 representing discharge capacity (from 0-0.006 Ah), a right y-axis 154 representing coulombic efficiency (80-100%) and an x-axis 156 representing cycle number (from 0 to 50 cycles). Squares 158 refer to the electrode comprising a single active layer and circles 160 refer to the electrode comprising three layers. The graph 150 shows that the tri-layered electrode has a superior discharge capacity and coulombic efficiency relative to the second electrode comprising a single active layer.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode comprising:
a first active layer comprising a first active material;
an interlayer comprising a conductive material; and
a second active layer comprising a second active material,
wherein the interlayer is disposed between the first active layer and the second active layer.

2. The electrode according to claim 1, wherein one of the first active layer and the second active layer is disposed on a current collector comprising a material selected from the group consisting of copper, aluminum, carbon, lithium, nickel, stainless steel, tantalum, titanium, tungsten, vanadium, and combinations thereof.

3. The electrode according to claim 1, wherein the electrode is an anode and the first active material and the second active material independently comprise a negative electroactive material.

4. The electrode according to claim 1, wherein the first active material and the second active material are independently selected from the group consisting of graphite, lithium titanate oxide Li₄Ti₅O₁₂ (LTO), metal oxides of MO where M is selected from the group consisting of cobalt (Co), nickel (Ni), copper (Cu), or iron (Fe), silicon (Si), silicon nanoparticles, silicon-containing alloys, tin (Sn), tin-containing alloys, and combinations thereof.

5. The electrode according to claim 1, wherein the electrode is a cathode and the first active material and the second active material independently comprise a positive electroactive material.

6. The electrode according to claim 1, wherein the first active material and the second active material are independently selected from the group consisting of transition metal oxides, olivine-structured LiMPO₄ where M is Fe, Mn, Co, or Ni, layer oxides of LiMO₂ wherein M is Mn, Ni, Co, or Cr, spinel-structured LiM₂O₄ where M is Mn or Fe, and combinations thereof.

7. The electrode according to claim 1, wherein the conductive material comprises carbon.

8. The electrode according to claim 1, wherein the conductive material is selected from the group consisting of carbon, diamond-like carbon, carbon fibers, carbon nanotubes, carbon black, metallic wires, metallic particulates, and combinations thereof.

9. An electrode comprising:
a first active layer disposed on a copper substrate, the first active layer comprising silicon (Si);
an interlayer disposed on the first active layer such that the first active layer is located between the copper substrate and the interlayer, the interlayer comprising carbon; and
a second active layer disposed on the interlayer such that the interlayer is located between the first active layer and the second active layer, the second active layer comprising Si.

10. The electrode according to claim 9, wherein the first active layer, the interlayer, and the second active layer have a combined thickness of greater than or equal to about 15 μm to less than or equal to about 450 μm.

11. A battery comprising the electrode according to claim 9.

12. A method of fabricating an electrode, the method comprising:
disposing a first composition comprising a first active material onto a substrate;
annealing the first composition to generate a first active layer on the substrate;
disposing a second composition comprising a conductive material onto the first active layer;
annealing the second composition to generate an interlayer on the first active layer;
disposing a third composition comprising a second active material onto the interlayer; and
annealing the third composition to generate a second active layer on the interlayer.

13. The method according to claim 12, wherein the first composition is a first aqueous ink, the second composition is a non-aqueous ink, and the third composition is a second aqueous ink, and the method further comprises:
generating the first aqueous ink and the second aqueous ink independently and independently by combining:
one of the first active material and the second active material,
a first conductive filler,
a first binder, and
an aqueous solvent; and
generating the second composition by combining:
the conductive material,
a second conductive filler,
a second binder, and
a non-aqueous solvent.

14. The method according to claim 13, wherein disposing the first composition, the second composition, and the third composition is performed individually and independently by spreading with a doctor blade, die coating, or spray coating.

15. The method according to claim 13, wherein the annealing the first composition, the second composition, and the third composition comprises individually and independently incubating the first composition, the second composition, and the third composition at a temperature of greater than or equal to about ambient temperature to less than or equal to about 120° C. for a time of greater than or equal to about 30 seconds to less than or equal to about 12 hours.

16. The method according to claim 13, wherein the first active material and the second active material are independently selected from the group consisting of graphite, lithium titanate oxide Li₄Ti₅O₁₂ (LTO), metal oxides of MO where M is selected from the group consisting of cobalt (Co), nickel (Ni), copper (Cu), or iron (Fe), silicon (Si), silicon nanoparticles, silicon-containing alloys, tin (Sn), tin-containing alloys, and combinations thereof, and the conductive material is selected from the group consisting of carbon, diamond-like carbon, carbon fibers, carbon nanotubes, carbon black, metallic wires, metallic particulates, and combinations thereof.

17. The method according to claim 13, wherein the first composition is disposed onto a first decal, the second composition is disposed onto a second decal, and the third composition is disposed onto a third decal, and disposing the first composition, the second composition, and the third composition is performed individually and independently by disposing the first decal, the second decal, or the third decal onto the substrate, the first active layer, or the interlayer, respectively.

18. The method according to claim 17, wherein the annealing the first composition, the second composition, and the third composition comprises individually and independently hard pressing the first decal, the second decal, and the third decal.

19. The method according to claim 18, wherein after the annealing the method comprises:
removing the first decal from the first composition, removing the second decal from the second composition, and removing the third decal form the third composition.

20. The method according to claim 12, further comprising:
generating an additional interlayer on the second active layer; and
generating an additional active layer on the additional interlayer.
